(19) United States
(12) Patent Application Publication
(10) Pub. No.: US 2017/0013815 A1
(43) Pub. Date: Jan. 19, 2017

(54) FISHING LURE

(71) Applicant: Dana Christopher Cook, Boynton Beach, FL (US)

(72) Inventor: Dana Christopher Cook, Boynton Beach, FL (US)

(21) Appl. No.: 15/210,114

(22) Filed: Jul. 14, 2016

Related U.S. Application Data
(60) Provisional application No. 62/192,185, filed on Jul. 14, 2015.

(51) Int. Cl. A01K 85/14

(52) U.S. Cl. CPC A01K 85/14

(57) ABSTRACT

A fishing lure adapted to mimic sea turtle hatchlings in size, shape and movement is provided. The replica lure may provide a plurality of planar lure members that sandwich a proximal portion of a hook so that the distal portion is disposed adjacent to and underneath the mimicked sea turtle profile. The proximal end of the hook may provide a built up portion that is sandwiched, thereby providing voids between some of the plurality of lure members further mimicking the profile of a baby sea turtle, while also enabling a seesaw effect when the replica lure and/or hook is bitten by a fish.

### CROSS-REFERENCE TO RELATED APPLICATION

This application claims the benefit of priority of U.S. provisional application No. 62/192,185, filed 14 Jul. 2015, the contents of which are herein incorporated by reference.

### BACKGROUND OF THE INVENTION

The present invention relates to fishing lures and, more particularly, to a fishing lure adapted to mimic sea turtle hatchlings in size, shape and movement, thereby adding to the arsenal of the fisherman, while at the same time offering an effective alternative that reduces and/or deters predation and poaching of real, endangered sea turtle hatchlings.

Many species of fish eat sea turtle hatchings, instinctively knowing when the hatching seasons are, and actively preying on them even when otherwise satiated. Knowing this, fishermen and poachers will collect sea turtle hatchlings and use them for bait, even though in most places it is illegal or unethical to fish with live sea turtles. Already endangered, using sea turtle hatchings to fish further reduces their numbers and drives them closer to extinction. Therefore, the use of replica hatchlings that mimic the movement and behavior of real hatchings could protect the sea turtle population from predation and poaching. Furthermore, such replica hatchlings afford the opportunity to conduct scientific research through tagging and other data collection methodologies for studying sea turtles and their predators.

As can be seen, there is a need for a fishing lure adapted to mimic sea turtle hatchlings in size, shape and movement to not only protect the endangered sea turtle population but also to be used to learn more about sea turtles and raise awareness in the public arena.

### SUMMARY OF THE INVENTION

In one aspect of the present invention, a fishing lure adapted to mimic sea turtle hatchlings in size, shape and movement includes a plurality of planar sheets of absorbent lure material providing a top member; a plurality of flipper members; and a bottom member, wherein the bottom member provides a hook slot; a hook, wherein a distal portion of the hook protrudes through the hook slot; and a built-up portion provided along a proximal portion of the hook, wherein the built-up portion and a portion of each of the plurality of flipper members are sandwiched between the top and bottom member so that a remaining portion of each of the plurality of flipper members pivot relative to the top and bottom member.

In another aspect of the present invention, the fishing lure adapted to mimic sea turtle hatchlings in size, shape and movement includes a plurality of planar sheets of absorbent lure material, having a top member; a plurality of flipper members; and a bottom member, wherein the bottom member provides a hook slot; a hook, wherein a distal portion of the hook protrudes through the hook slot; a hook fastener connecting the hook to the bottom member; a neck fastener connecting the hook to the top member; and a built-up portion provided along a proximal portion of the hook, wherein the built-up portion and a portion of each of the plurality of flipper members are sandwiched between the top and bottom member so that a remaining portion of each of the plurality of flipper members pivot relative to the top and bottom member, and wherein the built-up portion provides a first void between the top member and the sandwiched proximal portion of the hook; and a second void between the bottom member and the sandwiched proximal portion of the hook.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a top perspective view of an exemplary embodiment of the present invention;

FIG. 3 is a bottom perspective view of an exemplary embodiment of the present invention;

FIG. 4 is an exploded view of an exemplary embodiment of the present invention; and

FIG. 5 is a section view of an exemplary embodiment of the present invention, taken along line 5-5 of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a fishing lure adapted to mimic sea turtle hatchlings in size, shape and movement. The replica lure may provide a plurality of planar lure members that sandwich a proximal portion of a hook so that the distal portion is disposed adjacent to and underneath the mimicked sea turtle profile. The proximal end of the hook may provide a built up portion that is sandwiched, thereby providing voids between some of the plurality of lure members further mimicking the profile of a baby sea turtle, while also enabling a seesaw effect when the replica lure and/or hook is bitten by a fish.

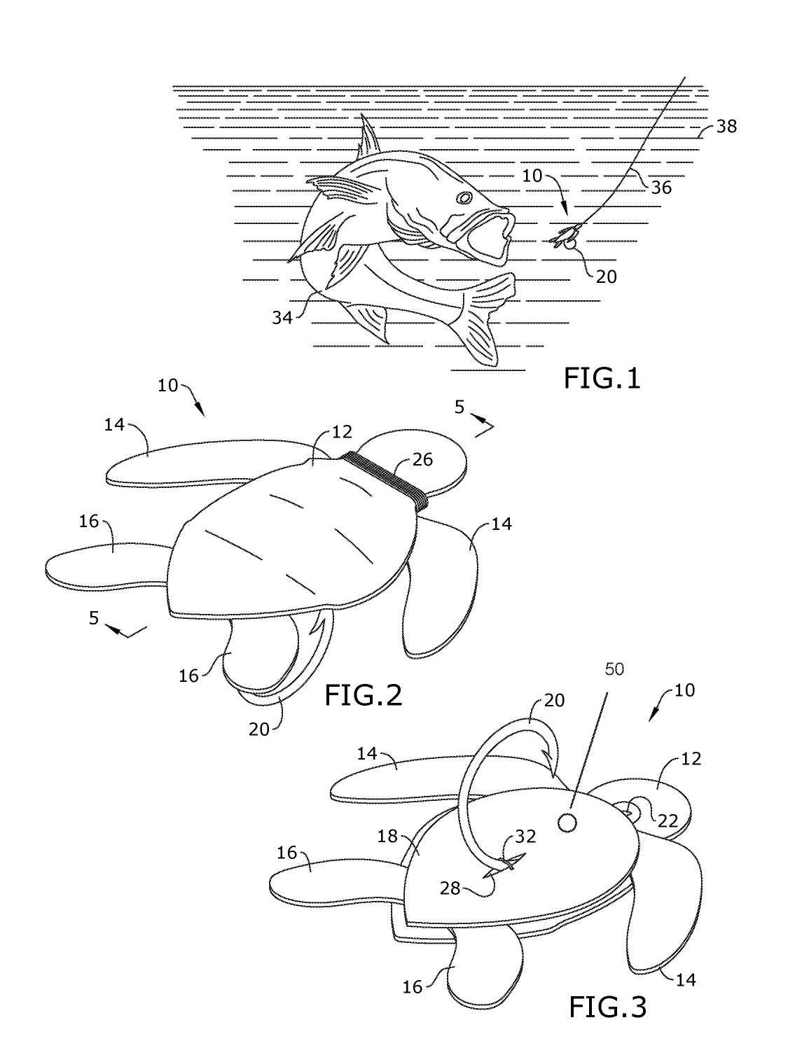

Referring to FIGS. 1 through 5, the present invention may include a replica lure 10. The replica lure 10 may provide a plurality of lure members including a top member 12, a bottom member 18 and a plurality of flipper members 14 and 16. The replica lure 10 may include a hook 20 having a hook eye 22 and a barb 40.

The plurality of lure members may be made out of any durable material that floats when dry, yet absorbs water to a sufficient degree to have an overall density equal to or slightly greater than the density of the water it absorbs, thereby tending to submerge when at least partially saturated. In certain embodiments, said absorbent material may take on an overall density of up to 105% of the density of the water it absorbs. In some embodiments, said absorbent material may be faux leather so that the replica lure 10 floats and submerges making it very life like in the water 38.

The plurality of lure members may be planar sheets of said absorbent material, such as the faux leather. The plurality of flipper members 14 and 16 may be attached to the top member 12 and/or the bottom member 18 so that they are flexible and somewhat pivotally connected thereto, thereby the flipper members 14 and 16 move naturally in the currents and waves of the water 38 relative to the top and bottom members 12, 18, mimicking the swimming movement of a hatchling, when dragged through the water 38. The size of the replica lure 10 and thus its constituent parts is key as well.

A method of making the present invention includes the following. An individual may hand cut each member 12-18 from a pattern. In certain embodiments, the top member 12 may be dimensioned and adapted to mimic the profile of the head, neck and shell of a sea turtle hatchling; the plurality of flipper members 14 and 16 may be dimensioned and adapted to mimic the front and rear flippers of a sea turtle hatchling; and the bottom member 18 may be dimensioned and adapted to mimic the profile of an underbelly of a sea turtle hatchling.

The hook 20 may provide a built-up portion 24 near a proximal end thereof. In certain embodiments, the individual may place the hook 20 in a vice so that its shank may be wrapped with a hook threading forming the built-up portion 24. Said built-up portion 24 provides a volume greater than that of the hook shank, while creating a base for a lifting fiber (not shown). The (linear) volume difference between the built-up portion 24 and the hook shank may be in the range of between 2 to 1 and 5 to 1. The (linear) volume may be defined by the cylindrical or equivalent diameter of the built-up portion 24 and the hook shank. The lifting fiber may be removably attached to lift the top member 12 so as to apply a hardening agent (not shown). The hardening agent may also provide adhesive properties.

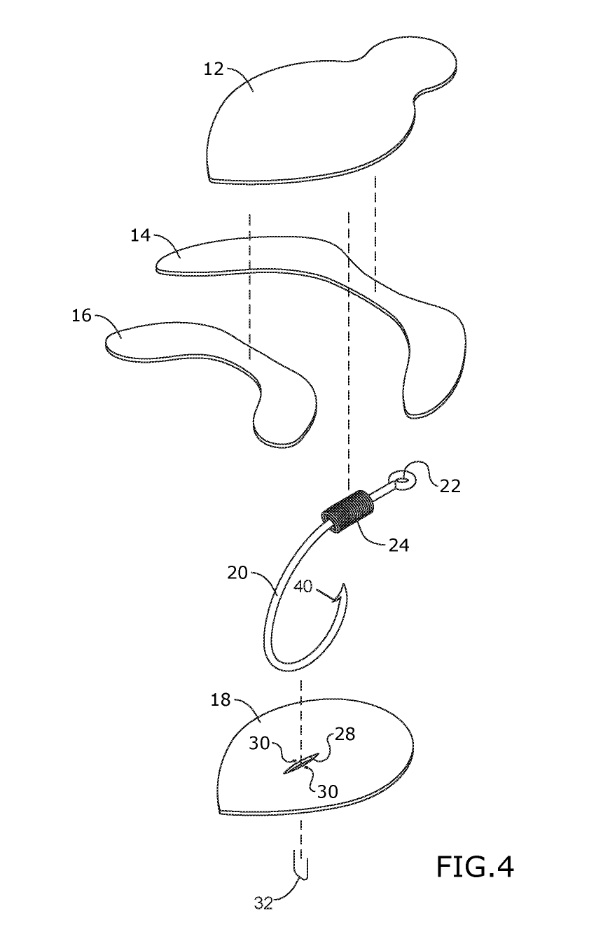

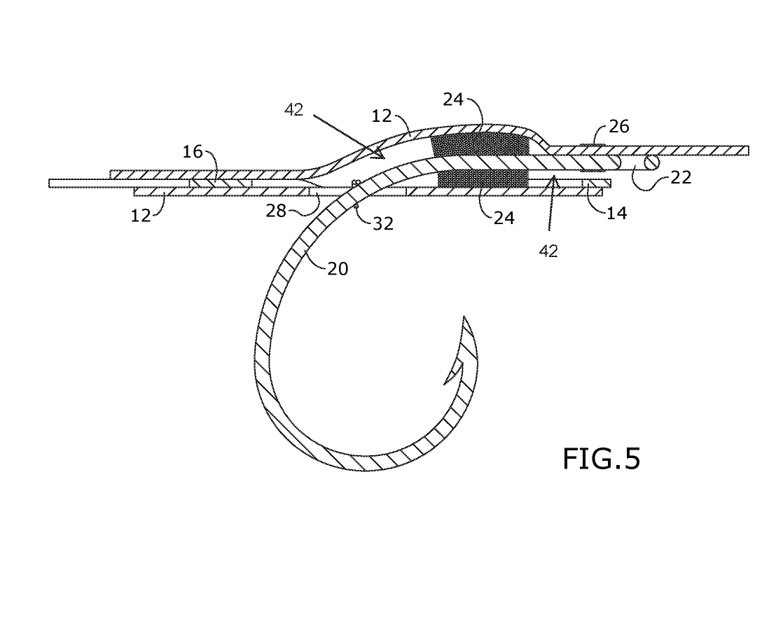

The planar sheet of the bottom member 18 may provide a hook opening 28 generally centrically disposed therein, as illustrated in FIG. 4. The bottom member 18 may provide fastener holes 30 disposed on either side of the hook opening 29. Then, the individual may slide the hook 20 through the hook opening 28 so that the barb 40 is exposed. Then the individual may provide a hook fastener 32 to affix the hook 20 to the bottom member 18, typically by using the fastener holes 30 to do so. In certain embodiments, the hook fastener 32 may be a flexible wire. Then the hardening agent may be applied to a portion of the bottom member 18 so that the top member 12 may be affixed thereto, sandwiching the built-up portion 24 there between, as illustrated in FIGS. 4 and 5. The top member 12 may be disposed so that the head portion thereof overhangs the hook eye 22, thereby concealing the hook from would be predators approaching from the top member side of the replica lure 10. Then the hook 20 may be affixed to the top member 12 by a neck fastener 26. In certain embodiments, the neck fastener 26 may be a threading that wraps about a neck portion of the top member 12 to engage a portion of the hook 20, as illustrated in FIG. 5. The plurality of lure members may then be further secured by the hardening agent applied along overlapping portions thereof.

Referring to FIG. 5, the resulting replica lure 10, through the presence of the built-up portion 24 and the opposing hook fastener 32 and neck fastener 26 provide opposing voids 42 between the hook 20 and the top member 12 on one portion (adjacent the hook fastener 32) and the hook and the bottom member 18 on another portion (adjacent the neck fastener 26). Such opposing voids 42 further provide a profile mimicking a baby sea turtle as well as enable a seesaw effect for the hook 20, facilitating a secure catch when a fish 34 bites onto the hook 20 and replica lure 10. The hook 20 may be a circle hook, allowing for healthier more humane releases.

A method of using the present invention may include the following. The replica lure 10 disclosed above may be provided. A user may affix a fishing line 36 to the replica lure 10 by conventional methods. The replica lure 10 can then be fished most effectively during various breeding seasons near the beaches, but, more often than not, fished around Sargassum weedlines or debris by drifting or casting to the fish 34 that you may or may not see. The replica lures 10 can be weighted for bottom fishing either anchored or drifting. You can create actionable movements with the rod tip to mimic life as you fish, wherein the key is to get the replica lure 10 wet so that the absorbent material enables the above mentioned properties.

In certain embodiments, the replica lures can be tagged by providing a data tag 50, to be used by researchers to study what fish feed on the replica lures 10, when and where. The data tag 50 could be adapted to collect data on what species of fish eat the hatchlings, the numbers, and the like. The data tags 50 may be imprinted underneath the replica lure 10 and registered with the appropriate researchers so that the collected data may be published to the public, which could raise awareness to the public about sea turtles and other aquatic life.

Moreover, the replica lure 10 may mimic the size, shape, profile and characteristic of other aquatic life, such as a large Squid (for swordfishing), crabs, lobsters, and the like.

It should be understood, of course, that the foregoing relates to exemplary embodiments of the invention and that modifications may be made without departing from the spirit and scope of the invention as set forth in the following claims.

What is claimed is:

1. A device, comprising:
a plurality of planar sheets of absorbent lure material, comprising:
a top member;
a plurality of flipper members; and
a bottom member, wherein the bottom member provides a hook slot;
a hook, wherein a distal portion of the hook protrudes through the hook slot; and
a built-up portion provided along a proximal portion of the hook, wherein the built-up portion and a portion of each of the plurality of flipper members are sandwiched between the top and bottom member so that a remaining portion of each of the plurality of flipper members pivot relative to the top and bottom member.

2. The device of claim 1, wherein the top member, the plurality of flipper members, and the bottom member are dimensioned and adapted to mimic the shapes and sizes of a shell portion, front and rear flipper portions, and an under portion, respectively, of a baby sea turtle.

3. The device of claim 1, further comprising a hook fastener connecting the hook to the bottom member.

4. The device of claim 1, further comprising a neck fastener connecting the hook to the top member.

5. The device of claim 1, wherein the built-up portion provides:
a first void between the top member and the sandwiched proximal portion of the hook; and
a second void between the bottom member and the sandwiched proximal portion of the hook.

6. The device of claim 1, wherein the built-up portion has a linear volume approximately 3 times that of a linear volume of the proximal portion of the hook.

7. A device, comprising:
a plurality of planar sheets of absorbent lure material, comprising:
a top member;
a plurality of flipper members; and
a bottom member, wherein the bottom member provides a hook slot;
a hook, wherein a distal portion of the hook protrudes through the hook slot;
a hook fastener connecting the hook to the bottom member;
a neck fastener connecting the hook to the top member; and
a built-up portion provided along a proximal portion of the hook, wherein the built-up portion and a portion of each of the plurality of flipper members are sandwiched between the top and bottom member so that a remaining portion of each of the plurality of flipper members pivot relative to the top and bottom member, and wherein the built-up portion provides a first void between the top member and the sandwiched proximal portion of the hook; and a second void between the bottom member and the sandwiched proximal portion of the hook.
